(19) United States
(12) Patent Application Publication
(10) Pub. No.: US 2003/0146922 A1
(43) Pub. Date: Aug. 7, 2003

(54) System and method for diminished reality

(76) Inventors: Nassir Navab, Plainsboro, NJ (US); Yakup Genc, Plainsboro, NJ (US); Julien Esteve, Bourges (FR)

Correspondence Address: Siemens Corporation, Intellectual Property Department, 186 Wood Avenue South, Iselin, NJ, 08830, US

(21) Appl. No.: 10/325,390

(22) Filed: Dec. 20, 2002

Related U.S. Application Data
(60) Provisional application No. 60/343,417, filed on Dec. 21, 2001.

(51) Int. Cl. G09G 5/00

(52) U.S. Cl. 345/633

(57) ABSTRACT

A method for removing a portion of a foreground of an image comprises determining a portion of a foreground to remove from a reference image, determining a plurality of source views of a background obscured in the reference image, determining a correlated portion in each source view corresponding to the portion of the foreground to remove, and displaying the correlated portion in the reference image.

### BACKGROUND OF THE INVENTION

1. Field of the Invention

The present invention relates to augmented reality visualization systems, and more particularly to a method for removing an object in an image of a real scene and rendering an image of the background behind the object.

2. Discussion of the Prior Art

Removal and replacement of an object in an image can be referred to as diminished reality. Removal and replacement means that whatever is in the back of the object should be rendered when the object is removed. This rendering can be realistic or approximate.

The goal is to remove an object of interest from a reference view and render the corresponding portion of the image with a proper background. Diminished reality methods can be implemented in an augmented reality system to replace a real object with a virtual one. Several researchers have used the “Diminished Reality” term in the past. Mann and Fung (“VideoOrbits on Eye Tap devices for deliberately Diminished Reality or altering the visual perception of rigid planar patches of a real world scene,” Proceedings of the International Symposium on Mixed Reality (ISMR 2001), March, 2001.) proposed a method for removing the content of a planner object and replacing it with another texture in a movie by video orbit. Wang and Adelson (“Representing Moving Images with Layers,” IEEE Transactions on Image Processing Special Issue: Image Sequence Compression, 3(5):625-638, September 1994) proposed a method for segmenting a sequence of video images into multiple layers and rendering the same video when removing one of the layers. Lepetit and.Berger (“A Semi-Automatic Method for Resolving Occlusion in Augmented Reality,” Proceedings of IEEE International Conference on Computer Vision and Pattern Recognition (CVPR 2000), Volume 2, June 2000) proposed a method for tracking a user-defined boundary in a set of moving images and detecting the occlusion to remove the object from the scene.

The above methods use a dense temporal sequence of images taken by video cameras. This allows them to segment and track the objects on their apparent motion in the video sequence. However, this can be computationally expensive and slow.

Rendering new images from multiple view has also been studied by different researchers. Laveau and Faugeras (“3-d scene representation as a collection of images,” Proceedings of 12th International Conference on Pattern Recognition, volume 1, pages 689-691, 1994) use the consistency along the epipolar lines in multiple view to render the new image. Sietz and Dyer (“View Morphing,” Proc. SIGGRAPH 96, 1996, 21-30) proceed to image rectification and then use the disparity maps, and McMillan and Bishop (“Plenoptic Modeling: An Image-Based Rendering System,” Proceedings of SIGGRAPH 95, pp. 39-46) use the Plenoptic modeling for image based rendering. In these works, a new image of the whole scene is rendered, which can be computationally expensive.

Therefore, a need exists for a fast and practical system and method for removing or replacing an object in image where the number of available source images is limited.

### SUMMARY OF THE INVENTION

According to an embodiment of the present invention, a method for removing a portion of a foreground of an image comprises determining a portion of a foreground to remove from a reference image, determining a plurality of source views of a background obscured in the reference image, determining a correlated portion in each source view corresponding to the portion of the foreground to remove, and displaying the correlated portion in the reference image.

At least two source views are determined.

The correlated portion comprises a plurality of correlated subdivisions. Each correlated subdivision has an independent depth. The correlated portion is one of a triangle, a circle, a rectangle, and/or any polygon.

According to an embodiment of the present invention, a method for removing a portion of a foreground of an image comprises determining a plurality of calibrated images comprising a reference image and a plurality of source images, and determining a set of three-dimensional coordinates of the portion of the foreground. The method comprises determining a frustum going through a plane parallel to a reference image plane defined by the portion of the foreground, determining a plurality of virtual planes at different depths within the frustum, and determining a virtual image of the portion of the foreground in each source view. The method further comprises determining a homography between the virtual image and the source image for each source image, determining a correlation for each virtual image among the plurality of source images, and superimposing a virtual image having a desirable correlation over the portion of the foreground.

The method comprises dividing the virtual image having the desirable correlation and re-iterating the procedure for each of these divisions.

The homography is a projection of the virtual image in the source image, wherein the virtual image corresponds to a given depth relative to the reference image.

Determining the correlation further comprises determining a depth corresponding to the virtual image that maximizes the correlation from among a plurality of virtual images having different depths.

Determining a frustum comprises one of determining a perspective based frustum and a paraperspective based frustum.

According to an embodiment of the present invention, a program storage device is provided, readable by machine, tangibly embodying a program of instructions executable by the machine to perform method steps for removing a portion of a foreground of an image. The method comprises determining a portion of a foreground to remove from a reference image, determining a plurality of source views of a background obscured in the reference image, determining a correlated portion in each source view corresponding to the portion of the foreground to remove, and displaying the correlated portion in the reference image.

### BRIEF DESCRIPTION OF THE DRAWINGS

Preferred embodiments of the present invention will be described below in more detail, with reference to the accompanying drawings:

FIG. 1 is an illustration of a method according to an embodiment of the present invention;

FIG. 2 is a diagram of a system according to an embodiment of the present invention;

FIG. 3 is a flowchart of a method according to an embodiment of the present invention;

FIG. 4 is an illustration of a method according to an embodiment of the present invention;

FIG. 5 is a graph of a correlation between X and y for an experimental setup according to an embodiment of the present invention; and

FIG. 6 is a diagram of views through an image plane and reference plane according to an embodiment of the present invention.

### DETAILED DESCRIPTION OF PREFERRED EMBODIMENTS

According to an embodiment of the present invention, a portion of an image can be replaced. The background, hidden by the portion of the image being replaced, is approximated by a set of planar patches of a particular orientation. Alternatively, the imaging geometry can be modeled by paraperspective projection. In this way, a simple and efficient method for diminished reality can be achieved.

A method according to an embodiment of the present invention can assume that the world is piecewise planar or use a paraperspective model of a projection for a camera.

Given a set of calibrated images of a real scene, an object from a first image, the reference image, can be removed using objects from two or more other images. These other images can be referred to as source images. The borders of the objects, which are preferably rectangular, can be assumed to be identified in the reference image and the source image. Alternatively, a reconstructed three-dimensional model of the object to be removed can be projected.

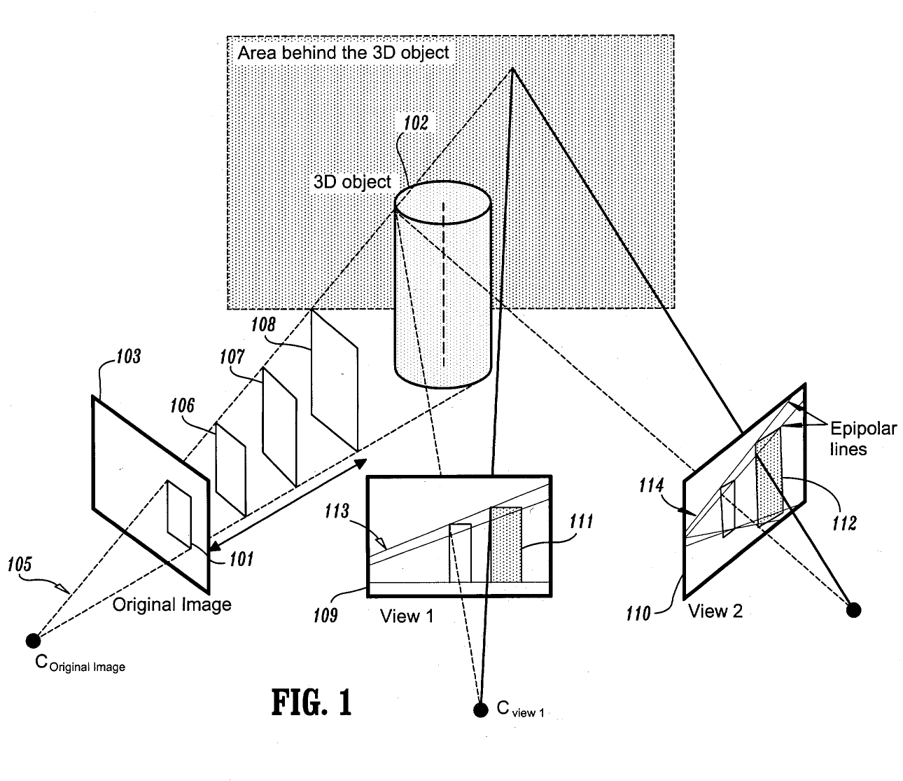

Referring to FIG. 1, a rectangular box 101 encapsulating the object to be removed 102 is identified in a reference image 103. The box 101 can be called the object-rectangle. It should be noted that other shapes can be used, such as squares, circles, triangles, and polygons. A frustum 105 originating from a center of a reference camera and passing through the object-rectangle 101 can be defined. Virtual planes 106-108 can be generated from the object-rectangle 101 and projected in the reference images 109, 110 as virtual rectangles 111, 112. For each reference image 109, 110, a homography 113, 114, between the images of the virtual rectangles 111, 112 and the source rectangle 101 can be identified. A homography is a planar transformation, in general defined by a 3×3 matrix, which maps a planar object onto another.

For a range of depth of the virtual planes 106-108 a correlation of pixel intensity between the reference views of the rectangle can be determined, that is, as between the source rectangle 101 and the virtual rectangles 111, 112.

As shown in FIG. 1, a single rectangle 101 is considered. The rectangle can be divided into rectangles or triangles for subdivision to fit onto a background, for example, a non-planar background. The subdivided rectangles/triangles form a mesh encapsulating the background image.

Note that the method is not limited to calibrated images. The method can also be applied to un-calibrated orthographic, weak-perspective and full-perspective images as well as posing the problem in projective geometry.

It should be noted that the subdivision of the initial reference rectangle will allow the background object to be non-planar. In this case, subdivided rectangles/triangles can have different depths fitting into the surface of the background. The degree of subdivision can be limited by the resolution of the images. However, constraints from both images and the scene can increase the accuracy of the fit.

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture.

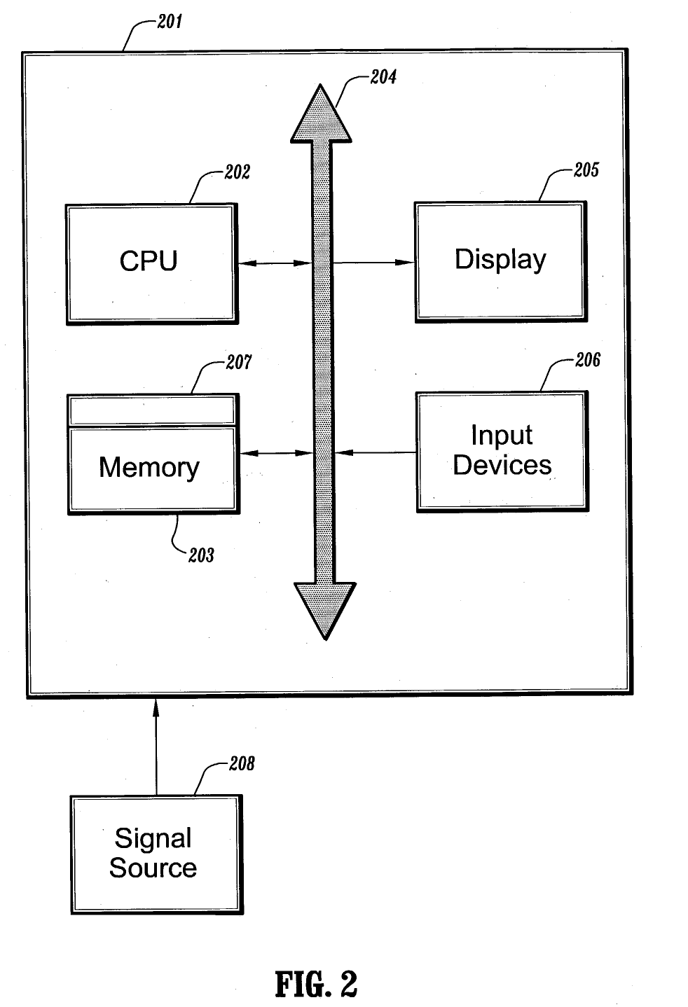

Referring to FIG. 2, according to an embodiment of the present invention, a computer system 201 for implementing the present invention can comprise, inter alia, a central processing unit (CPU) 202, a memory 203 and an input/output (I/O) interface 204. The computer system 201 is generally coupled through the I/O interface 204 to a display 205 and various input devices 206 such as a mouse and keyboard. The support circuits can include circuits such as cache, power supplies, clock circuits, and a communications bus. The memory 203 can include random access memory (RAM), read only memory (ROM), disk drive, tape drive, etc., or a combination thereof. The present invention can be implemented as a routine 207 that is stored in memory 203 and executed by the CPU 202 to process the signal from the signal source 208. As such, the computer system 201 is a general purpose computer system that becomes a specific purpose computer system when executing the routine 207 of the present invention.

The computer platform 201 also includes an operating system and micro instruction code. The various processes and functions described herein may either be part of the micro instruction code or part of the application program (or a combination thereof) which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

It can be assumed, for purposes of the following description and example, that a set of calibrated images are given and a set of three-dimensional coordinates of a model of the object to be removed/erased is provided.

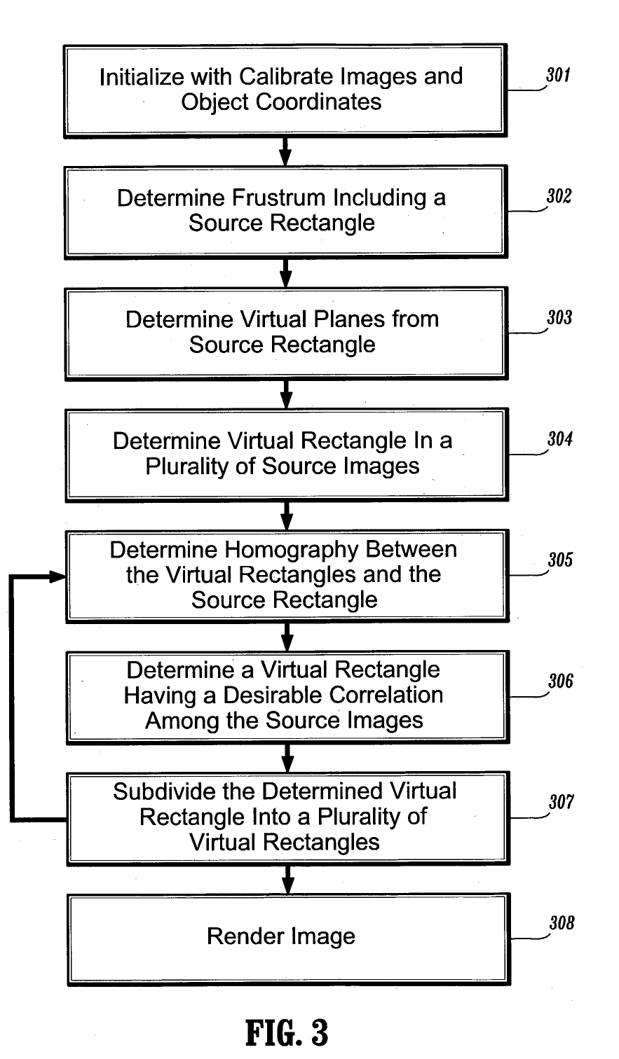

Referring to FIG. 3, once this initial information is given 301, the object can be projected and removed from the reference image to define a reference rectangle. A frustum can be created going through a plane parallel to the reference image plane that is also on the object of interest 302. The plane can be arbitrary, for example, the plane can be selected to be aligned to one of the principal axis of the world coordinate system. The frustum is defined by a source shape, e.g., a rectangle. From the source rectangle, a set of virtual planes can be created 303. The virtual planes are of some varying depth to the original image, for example, dividing a total depth into four equal parts. Each depth that can be adjusted according to a desired accuracy, and the images of the virtual rectangle in the source views can be determined 304. A set of homographies between the virtual rectangles and the source rectangles is determined 305. For example: let π be some arbitrary plane and let Pⱼεπ, j=1,2,3,4 projecting onto pⱼ,p′ⱼ in views [symbol] ₒ, [symbol] ₗ, respectively. A homography AεPGL₃ of ρ² is determined by the equation Apⱼ≅p′ⱼ,j=1,2,3,4. This homography maps each point of the projection of the plane on view [symbol] ₒ to the corresponding point on [symbol] ₗ.

The source rectangles are then warped onto the virtual rectangles, and a virtual rectangle having the highest correlation is selected 306. For example, for two source images, the following correlation coefficient is used:

$$< {I}_{1} ∘ {I}_{2} > = \frac{\sum ( {I}_{1} - {μ}_{1} ) ( {I}_{2} - {μ}_{2} )}{\sqrt{\sum {( {I}_{1} - {μ}_{1} )}^{2} \sum {( {I}_{2} - {μ}_{2} )}^{2}}}$$

where, μᵢ is the average value of image Iᵢ of each of the source rectangles.

The source images are the function of depth λ of the virtual plane. The following optimization can be solved:

$${argmax}_{λ} < {I}_{1} ( λ ) ∘ {I}_{2} ( λ ) >$$

wherein, the method searches for λ to maximize the correlation. A high correlation indicates that the corresponding virtual plane is desirable in the scene reflecting the background of the removed object as will be removed from the reference image. The selected virtual rectangle is subdivided in two or more virtual rectangles 307. Determining the homography and correlation can be repeated for each virtual rectangle of the subdivision to achieve improved correlation.

Once the depth Lambda for the virtual plane, corresponding to maximum correlation, is determined, the final rendering of the virtual plane can be achieved by one of the several methods 308. For example, by warping one of the source image portions on the virtual plane. Since the source images have the maximum correlation any of these warpings could be a good approximation of the background. Another example of the rendering is warping all the source image portions on the virtual plane and creating a new image, wherein the new image is an average of the source image portions. Each pixel on the final image is associated with an average of the intensity value of the corresponding pixels in the warped images. Yet another example, comprises warping all the source image portions on the virtual plane and creating a new image by averaging them, while weighting each image by a relative position and orientation of the camera to the virtual plane. This has the effect of giving more weight to a source image, if the source image is taken by a camera close to the background plane with an image plane more parallel to the virtual plane, as compared to other source images. Such a camera provides an image with higher resolution and lower perspective distortion from the background to be rendered, as compared to other cameras.

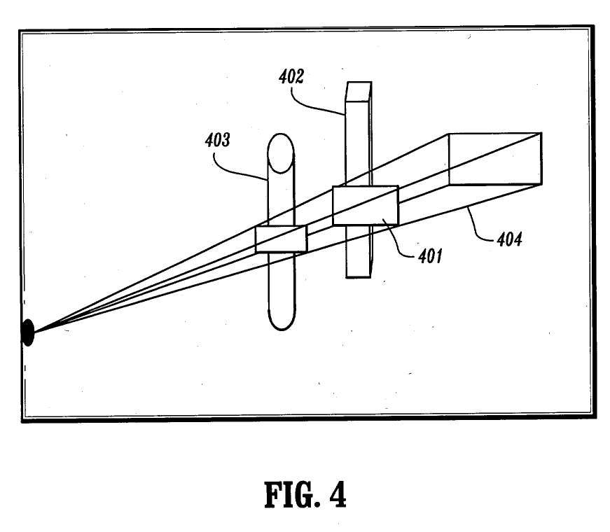

FIG. 4 shows an example of manipulation of the reference rectangle as seen in the source views. As can be seen, the place where a rectangle 401 hits the background 402 of the object to be removed 403 will have the best pixel level correlation between the views in the two source images. Epipolar lines (e.g., 404) are shown for convenience. For non-planar surface, further subdivision of the virtual rectangle can provide improved correlation. For example, further subdivision of a virtual rectangle can create a mesh to cover a cylindrical structure behind the object.

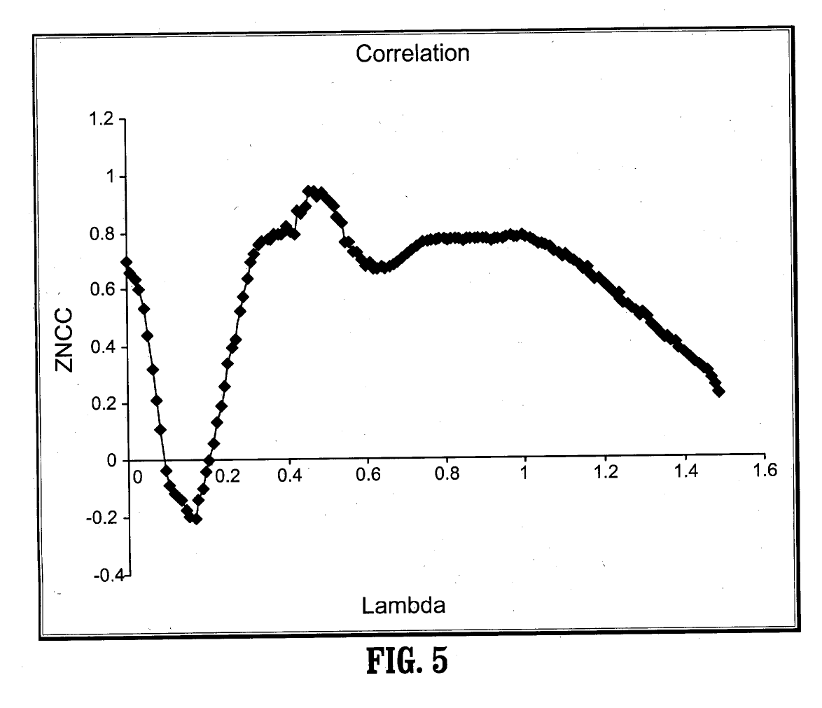

Thus, the method is not limited to the planar background but complex backgrounds can also be handled. Referring to FIG. 5, the graph illustrates how the correlation is changing with respect to the depth of the virtual rectangle. The best correlation gives a good approximation to the surface in the background of the object to be removed.

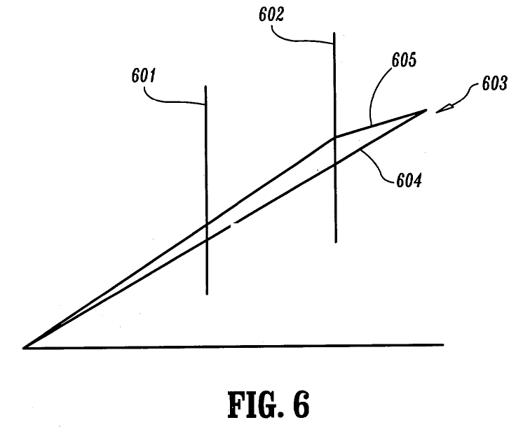

Referring to FIG. 6, an image plane 601 a reference plane 602 are shown with an object coordinate 603. The planes are intersected by a perspective view 604 and a paraperspective view 605. A paraperspective projection uses a set of object points projected onto the reference plane, that is parallel to the image plane. The paraperspective projection is done be determining intersection of the line parallel to a translation vector through the object point with the reference plane. The new point is projected onto the image plane according to the perspective projection model, by dividing by the depth.

Having described embodiments for a method for removing or replacing objects in image of real scenes, it is noted that modifications and variations can be made by persons skilled in the art in light of the above teachings. It is therefore to be understood that changes may be made in the particular embodiments of the invention disclosed which are within the scope and spirit of the invention as defined by the appended claims. Having thus described the invention with the details and particularity required by the patent laws, what is claimed and desired protected by Letters Patent is set forth in the appended claims.

What is claimed is:

1. A method for removing a portion of a foreground of an image comprising the steps of:
determining a portion of a foreground to remove from a reference image;
determining a plurality of source views of a background obscured in the reference image;
determining a correlated portion in each source view corresponding to the portion of the foreground to remove; and
displaying the correlated portion in the reference image.

2. The method of claim 1, wherein at least two source views are determined.

3. The method of claim 1, wherein the correlated portion comprises a plurality of correlated subdivisions.

4. The method of claim 3, wherein each correlated subdivision has an independent depth.

5. The method of claim 1, wherein the correlated portion is one of a triangle, a circle, a rectangle, and a polygon.

6. A method for removing a portion of a foreground of an image comprising the steps of:
determining a plurality of calibrated images comprising a reference image and a plurality of source images;
determining a set of three-dimensional coordinates of the portion of the foreground;
determining a frustum going through a plane parallel to a reference image plane defined by the portion of the foreground;
determining a plurality of virtual planes at different depths within the frustum;
determining a virtual image of the portion of the foreground in each source view;
determining a homography between the virtual image and the source image for each source image;
determining a correlation for each virtual image among the plurality of source images; and
superimposing a virtual image having a desirable correlation over the portion of the foreground.

7. The method of claim 6, further comprising the step of dividing the virtual image having the desirable correlation and re-iterating the procedure for each of these divisions.

8. The method of claim 6, wherein the homography is a projection of the virtual image in the source image, wherein the virtual image corresponds to a given depth relative to the reference image.

9. The method of claim 6, wherein the step of determining the correlation further comprises determining a depth corresponding to the virtual image that maximizes the correlation from among a plurality of virtual images having different depths.

10. The method of claim 6, wherein the step of determining a frustum comprises one of determining a perspective based frustum and a paraperspective based frustum.

11. A program storage device readable by machine, tangibly embodying a program of instructions executable by the machine to perform method steps for removing a portion of a foreground of an image, the method steps comprising:
determining a portion of a foreground to remove from a reference image;
determining a plurality of source views of a background obscured in the reference image;
determining a correlated portion in each source view corresponding to the portion of the foreground to remove; and
displaying the correlated portion in the reference image.

12. The method of claim 11, wherein two source views are determined.

13. The method of claim 11, wherein the correlated portion comprises a plurality of correlated subdivisions.

14. The method of claim 13, wherein each correlated subdivision has an independent depth.

15. The method of claim 11, wherein the correlated portion is one of a triangle, a circle, a rectangle, and a polygon.
